(19) United States
(12) Patent Application Publication
(10) Pub. No.: US 2010/0321414 A1
(43) Pub. Date: Dec. 23, 2010

(54) DISPLAY DEVICE

(76) Inventors: Takao Muroi, Osaka (JP); Kohji Fujiwara, Osaka (JP); Takayuki Murai, Osaka (JP)

Correspondence Address: BIRCH STEWART KOLASCH & BIRCH, PO BOX 747, FALLS CHURCH, VA, 22040-0747, US

(21) Appl. No.: 12/677,076

(22) PCT Filed: Sep. 26, 2008
(86) PCT No.: PCT/JP2008/067417

§ 371 Date: Mar. 8, 2010

(30) Foreign Application Priority Data
Sep. 27, 2007 (JP) 2007-251980

(51) Int. Cl. G09G 5/10; G09G 3/36

(52) U.S. Cl. 345/690; 345/102

(57) ABSTRACT

It is an object of the present invention to provide a display device that can improve the color reproductivity on a displayed image and improve the display quality. A liquid crystal display device (1) is provided with a backlight device (3) and a liquid crystal panel (2) configured to have capability of color display of information by using illumination light from the backlight device (3). The backlight device (3) has a plurality of illumination areas (Ha) with respect to a plurality of display areas provided on the liquid crystal panel (2), and light-emitting diodes (light sources) of RGB (8r, 8g, 8b) mixable with white light are provided for each illumination area (Ha). Its control part is provided with a backlight control part that determines for each of the light sources a luminance value of light emitted from each of the plural illumination areas (Ha) to a corresponding display area by using an inputted picture signal and that controls the drive of a backlight part, so that an area active backlight drive is carried out. The light-emitting diodes (light sources) of RGB (8r, 8g, 8b) have offset luminances that are set independently from each other.

### TECHNICAL FIELD

The present invention relates to a display device, in particular, a non-emission type display device such as a liquid crystal display device.

### BACKGROUND ART

Recently, for example, a liquid crystal display device has been used widely in a liquid crystal television, a monitor, a mobile telephone and the like, as a flat panel display having advantages such as thinness and light-weight in comparison with conventional Braun tubes. Such a liquid crystal display device includes a backlight device that emits light and a liquid crystal panel that displays a desired image by playing a role as a shutter with respect to light from a light source provided in the backlight device.

The above-described backlight device is classified roughly into a direct-type device an edge-light type device depending on the arrangement of the light source with respect to the liquid crystal panel. In a liquid crystal display device provided with a liquid crystal panel of 20 inches or more, a direct-type backlight device is used in general since such a direct-type backlight device can be made easily to be larger and with higher luminance in comparison with an edge-light type device. The majority of the direct-type backlight devices each has a lamp (discharge tube) including a plurality of cold cathode fluorescent lamps (CCFL) arranged opposite to a liquid crystal panel via a diffuser. However, mercury contained in the discharge tube composes an obstacle for recycling of a discharge tube to be wasted, environmental protection or the like. In light of this, a backlight device using a mercury-free light-emitting diode (LED) as a light source has been developed and come into practical use.

In a backlight device using LED, a tricolor LED that emits light of respective colors of red (R), green (G) and blue (B), a LED of white (W), or a LED unit as a combination of a white LED and a RGB LED has been used, and the backlight device is configured by arranging a number of LED units in matrix.

Some of conventional liquid crystal display devices using the above-described LED backlight devices, which have been disclosed, improve the color reproduction range with respect to a color signal inputted from the exterior or control the color balance and/or the white balance in accordance with a measurement result on the ambient luminance and/or the ambient temperature (see for example, JP 2005-234134 A, JP 2005-338857 A, and JP 2005-17324 A).

An example of conventional liquid crystal display devices using the above-mentioned LED backlight devices is described in JP 2006-343716 A. That is, this conventional liquid crystal display device has been suggested the following driving method (hereinafter, referred to as “area active drive”). Specifically, it has a liquid crystal panel divided into a plurality of regions (areas) and a driving part that controls selectively the luminance of light emitted from the LED in accordance with the divided areas, thereby improving the image quality of the conventional liquid crystal display device using a cold cathode fluorescent tube for the backlight device and further reducing the power consumption.

### DISCLOSURE OF INVENTION

### Problem to be Solved by the Invention

In the meantime, when configuring the above-described conventional liquid crystal display device so as to perform the area active drive, normally a RGB LED is used for the backlight device, and the luminance balance among the RGB is adjusted to express white color. For such methods of controlling a backlight device, for example, a monochrome area active drive for driving a RGB LED unit with a white gray scale (gradation) and a RGB independent area active drive for driving independently the RGB LED unit with respective colors of RGB have been put into practice.

Specifically, in the monochrome area active drive, the RGB LED unit is driven by aligning luminance value (luminance signal) of the remaining color with any of the luminance maximal value of RGB contained in an inputted picture signal. In the RGB independent area active drive, in accordance with the luminance values of the respective colors of RGB contained in the inputted picture signal, a luminance signal of corresponding LED in the RGB LED unit is generated, and thus the LED is driven.

In the RGB independent area active drive, the respective luminance signals of the numbers of LED units are set to differ from each other in accordance with the inputted picture signals. Specifically, in the RGB independent area active drive, for example, an output luminance signal of a LED unit is the highest luminance signal among luminance signals contained in the inputted picture signal in an area of a liquid crystal panel managed by the LED unit, and the number of pixels of the liquid crystal panel in the area managed by one LED unit is set to be 100 pixels. Further in this case, there are a variety of methods for determining the luminance signal of the LED unit. For example, the highest luminance signals of R, G, B among the picture signals in the 100 pixels are extracted, and the respective luminance values (luminance signals) of RGB of a corresponding LED of a LED unit are determined (modified) at the same ratio as the thus extracted luminance signals. In such a determination, for example, when R, G are the maximal luminance signals and B is a luminance of an intermediate level, the backlight device emits light of white-yellowish color from the LED unit.

However, in the conventional liquid crystal display device, the color reproducibility on the displayed image cannot be improved, and thus it is difficult to improve the display quality. Namely, in a case of monochrome area active drive in the conventional liquid crystal display device, since the respective LEDs of RGB are driven with the same luminance signal (luminance value), sometimes a vivid image cannot be displayed.

On the other hand, when the RGB independent area active drive is carried out in a conventional liquid crystal display device, the color of light from the backlight device varies. However, in the conventional liquid crystal display device, it is impossible to improve the color reproducibility of the display color by the color filter provided on the liquid crystal panel, and thus sometimes it is difficult to improve the display quality. Namely, sometimes in such a conventional liquid crystal display device, leakage of spectral (transmission) wavelength from the respective color filters of RGB (color filter crosstalk) are not taken into consideration sufficiently, which may result in color displacement that is recognized visually on the screen of the liquid crystal display device.

Hereinafter, the above-mentioned problems in the conventional liquid crystal display device will be specified below with reference to FIGS. 16-18.

FIG. 16 is a graph showing a CF property of a color filter and emission wavelengths of the respective light-emitting diodes of RGB. FIG. 17 is a chromaticity diagram (xy chromaticity diagram) showing the color reproduction range for a case of performing a RGB independent area active drive and a monochrome area active drive respectively in a conventional liquid crystal display device. FIGS. 18A and 18B are diagrams for illustrating specific examples of displayed images when the RGB independent area active drive and the monochrome area active drive are performed respectively in a conventional liquid crystal display device.

As indicated with a curve 50 in FIG. 16, in a LED unit of RGB, the LEDs of RGB emit red, green and blue lights respectively having peak wavelengths of about 635 nm, 530 nm and 450 nm. For the color filters, as indicated with curves 60r, 60g and 60b, the G color filter allows parts of the emission wavelengths of LEDs of B and R to interfere the emission wavelength of G LED and to be outputted. In this manner, the color filter allows parts of red and blue lights to pass through the G color filter.

Therefore, in the conventional liquid crystal display device for example, in a case of carrying out an RGB independent area active drive, since the respective luminance signals of RGB are modified at the ratio of the highest luminance signals of R, G, B, the color reproduction range fluctuates from the color reproduction range at the time that the each of the LEDs of RGB emits light of a single color, namely, from the maximal color reproduction range of the backlight device (indicated with a solid line 70 in FIG. 17) to the range as indicated with a broken line 80 in FIG. 17. As a result, in the conventional liquid crystal display device, when carrying out the RGB independent area active drive, color displacement may occur on the displayed image with respect to the picture signal (RGB separate signal) from the exterior.

On the other hand, in a case of carrying out the monochrome area active drive in a conventional liquid crystal display device, since the respective LEDs of RGB are driven by the same luminance signal, the color reproduction range does not change from the range illustrated with an alternate long and short dash line 90 in FIG. 17, and color displacement will not occur with respect to a picture signal from the exterior. However, the color reproduction range is narrow in comparison with the maximal color reproduction range as illustrated with the solid line 70, and thus clear and vivid image may not be displayed.

More specifically, in the conventional liquid crystal display device, for example in a case of displaying an image that white clouds are floating in a dark-blue sky, in the RGB independent active drive as shown in FIG. 18A, an unnatural image caused by the color displacement may be displayed on respective borders 101b, 102b between a sky 100 and clouds 101a, 102a. Namely, in the RGB independent area active drive, with regard to dark-blue chromaticity (x;0.249, y;0.262), the dark-blue sky 100 can be displayed (reproduced) with a desired dark-blue color. On the other hand, at the respective borders 101b, 102b between the sky 100 and the clouds 101a, 101b, the white light from all of the RGB LED of the LED unit that illuminates below the pixels of the respective clouds 101a, 102a and the blue light from the B LED included in the LED unit that illuminates below the pixels of the sky 100 are mixed with each other. And at the borders 101b, 102b, the B and G color filters interferes and thus the green light included in the white light is allowed to transmit, and displayed as a light-bluish color having a y-value higher by 0.01 (x;0.248, y;0.272), and an unnatural picture that is not required by the picture signal is displayed.

On the other hand, when the monochrome area active drive is carried out by using the same picture signal, only the color reproduction range indicated with the alternate long and short dash line 90 in FIG. 17 can be expressed as a picture. As a result, in FIG. 18B, the color of a sky 100′ becomes faint (light-blue) in comparison with the sky 100. The thus displayed sky lacks refreshing tone (color vividness), and sometimes an image (sky) requested by the picture signal cannot be displayed. It should be noted however, that since color displacement is not caused by the interference of a color filter in the vicinity of the borders between the sky 100′ and the respective clouds 101′, 102′, color change does not occur in the vicinity of the borders.

As mentioned above, the conventional liquid crystal display devices have problems. Namely, they display images having color displacement with respect to the picture signal, or cannot display a clear and vivid image characterizing the LED. Due to such problems, the color reproducibility on the displayed image cannot be improved, and it has been difficult to improve the display quality.

Therefore, with the foregoing in mind, it is an object of the present invention to provide a display device that can improve the color reproducibility on the displayed image and to improve the display quality.

### Means for Solving Problem

For achieving the above-mentioned object, a display device according to the present invention is a display device includes: a backlight part that has light sources; and a display part that has a plurality of pixels and that is configured to be capable of color display of information by using illumination light from the backlight part. The display device further includes: a plurality of illumination areas that are provided on the backlight part and that allows light from the light sources to enter respectively a plurality of display areas provided on the display part; and a control part that controls drive of the backlight part and drive of the display part by using an inputted picture signal. The backlight part is provided with light sources of at least two colors mixable with white light for each of the illumination areas; and offset luminances of the light sources of at least two colors are set independently from each other.

In the thus configured display device, light sources of at least two colors mixable with white color are provided on each of the illumination areas, and in the light sources of at least two colors, offset luminances are set independently from each other. Thereby, the control part can control independently the offset luminance for each light source, and thus the luminance value of each light source can be determined suitably in accordance with the inputted picture signal. As a result, unlike the above-mentioned examples according to conventional techniques, the color reproducibility on the displayed image can be improved, and the display quality can be improved.

Here, the offset luminance denotes a luminance signal that causes illumination of blue and red of at least a value obtained by multiplying the value of the luminance signal of green by a certain ratio (or by a certain difference with respect to the value of the luminance signal of green), when the value of the luminance signal of green is larger than the values of luminance signals of blue and red in a request signal (e.g., a picture signal) instructed by the exterior to the light sources.

It is preferable in the display device that the display part is provided with a color filter for each of the pixels, the control part is provided with a backlight control part that determines for each of the light sources a luminance value of light emitted from each of the plural illumination areas to a corresponding display area by using the inputted picture signal and controls the drive of the backlight part, and the backlight control part is provided with a luminance determining part that corrects and determines a luminance value determined for each of the light sources by using a correction coefficient predetermined on the basis of a predetermined CF property of the color filter and a predetermined emission property of the light sources.

In this case, the luminance determining part is capable of determining more suitably the luminance value for every light source while suppressing occurrence of color displacement with respect to the inputted picture signal, thereby improving the color reproducibility on the displayed image and improving surely the display quality.

Further, it is possible in the display device that light-emitting components that respectively emit light of red, green and blue are used for the light sources; the display part is provided with a color filter for each of the pixels; the control part is provided with a backlight control part that determines for each of the light sources the luminance value of light emitted from each of the illumination areas to a corresponding display area by using an inputted picture signal and controls the drive of the backlight part. The backlight control part is provided with a luminance determining part that compares the determined luminance value of green and the determined luminance value of blue by using the inputted picture signal, and determines the larger luminance value as the luminance value of green and as the luminance value of blue.

In this case, the luminance determining part can suppress surely occurrence of color displacement of the blue light with respect to the picture signal, as the blue light has the highest user visibility among the lights of red, green and blue recognized visually by the user through the color filter. Furthermore, the vividness of the displayed image can be improved, and thus the display quality can be improved.

Further, it is preferable in the display device that the control part is provided with a display control part that corrects the inputted picture signal by using the luminance value for each of the light sources from the backlight control part, and controls the drive of the display part for each of the pixels on the basis of corrected picture signal, and the display control part is provided with a color correction computing part that corrects the inputted picture signal by using the CF property.

In this case, the display control part can convert the inputted picture signal to a more suitable picture signal, thereby improving more surely the color reproducibility on the displayed image and the display quality.

Further, it is possible in the display device that the display control part corrects the luminance value for each of the light sources from the backlight control part, by using data of a preset PSF (point spread function).

In this case, the display control part can display the information displayed on the display part with a more suitable luminance, thereby improving the display quality.

Further, it is possible in the display device that the backlight control part corrects the luminance value of the light source determined at the luminance determining part, by using a preset minimal offset luminance value.

In this case, by using the minimal offset luminance value, the correction process for the picture signal at the display control part can be carried out precisely, and thus a suitable picture signal can be obtained surely.

Here, a minimal offset luminance value denotes a value of the minimal luminance where the light source is fed with electric power and lightened even when the luminance value of the light source determined at the backlight control part on the basis of a request signal instructed from the exterior with respect to the light source (for example, the gray scale (gradation)) is zero.

Further, it is possible in the display device that the backlight control part corrects the luminance value for each of the light sources determined at the luminance determining part so that a luminance balance of each illumination area has a value within a predetermined range with respect to an adjacent illumination area.

In this case, it is possible to prevent a great change in the luminance in each of the plural display areas, between the surrounding display areas, and thus the display quality is improved.

Further, it is possible in the display device that the backlight control part corrects the luminance value for each of the light sources determined at the luminance determining part so that consistency with a previous display operation at the display part is ensured.

In this case, it is possible to prevent a considerable change in the luminance from the previous display operation at the display part, and thus the display quality can be improved.

Further, it is preferable in the display device that the light sources of at least two colors are light-emitting diodes whose luminescent colors are different from each other.

In this case, a compact light source having an excellent color reproducibility and a long life can be configured easily and thus a small and high-performance display device can be configured.

### Effects of the Invention

According to the present invention, it is possible to provide a display device that can improve the color reproducibility on the displayed image, thereby improving the display quality.

### BRIEF DESCRIPTION OF DRAWINGS

FIG. 1 is a diagram for illustrating a schematic configuration of a liquid crystal display device according to Embodiment 1 of the present invention.

FIG. 2 is a plan view showing a configuration of a LED substrate of a backlight device as shown in FIG. 1.

FIG. 3 is a plan view showing an example of arrangement of LED unit on the LED substrate as shown in FIG. 2.

FIG. 4 is a plan view showing an example of configuration of the LED unit as shown in FIG. 3.

FIG. 5 is a plan view showing another example of configuration of the LED unit.

FIG. 6 is a block diagram showing a configuration of main components of the liquid crystal display device.

FIG. 7 is a block diagram showing a configuration of a data delay processing part as shown in FIG. 6.

FIG. 8 is a block diagram showing a configuration of a backlight data processing part as shown in FIG. 6.

FIG. 9 is a flow chart showing operations of an offset computing part as shown in FIG. 8.

FIG. 10 is a flow chart showing in detail operations of the G, B-LED decision process as shown in FIG. 9.

FIG. 11 is a flow chart showing in detail operations of the R, B-LED decision process as shown in FIG. 9.

FIG. 12 is a flow chart showing in detail operations of the R, G-LED decision process as shown in FIG. 9.

FIG. 13 is a diagram for illustrating a specific example of an image to be displayed by the liquid crystal display device.

FIG. 14 is a block diagram showing a configuration of a backlight data processing part in a liquid crystal display device according to Embodiment 2 of the present invention.

FIG. 15 is a flow chart showing operations of an offset computing part as shown in FIG. 14.

FIG. 16 is a graph showing a CF property of a color filter and emission wavelengths of respective light-emitting diodes of RGB.

FIG. 17 is an NTSC chromaticity diagram (NTSC ratio) of a color reproduction range when a RGB independent area active drive and a monochrome area active drive are performed respectively in a conventional liquid crystal display device.

FIGS. 18A and 18B are diagrams illustrating specific examples of displayed images when an RGB independent area active drive and a monochrome area active drive are performed respectively in the conventional liquid crystal display device.

### DESCRIPTION OF THE INVENTION

Hereinafter, the embodiments of the present invention will be specified with reference to the attached drawings. The description below refers to a case where the present invention is applied to a transmission type liquid crystal display device. It should be noted that the dimensions of the components in each of the drawings do not necessarily indicate the actual dimensions of the components and dimensional ratios among the respective components and the like.

### Embodiment 1

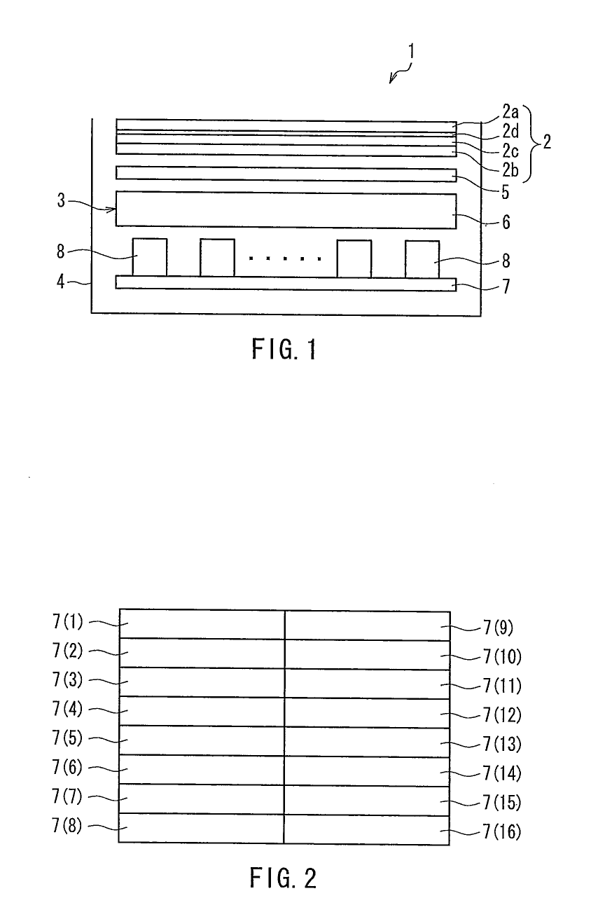

FIG. 1 is a diagram illustrating a schematic configuration of a liquid crystal display device according to Embodiment 1 of the present invention. In the drawing, a liquid crystal display device 1 of the present embodiment is provided with a liquid crystal panel 2 as a display part to be disposed with its upper surface as the visible side (display surface) and a backlight device 3 as a backlight part that is placed on the non-display surface of the liquid crystal panel 2 (i.e., the lower side in the drawing) and that emits light for illuminating the liquid crystal panel 2. Further in the present embodiment, the liquid crystal panel 2 and the backlight device 3 are contained integrally as a transmission type liquid crystal display device 1 inside a package 4. Further in the liquid crystal display device 1 of the present embodiment, a control part that controls drive of the liquid crystal panel 2 and drive of the backlight device 3 by using a picture signal inputted from the exterior is provided (the details will be stated below).

The liquid crystal panel 2 includes a pair of transparent substrates 2a, 2b, and a liquid crystal layer 2c and a color filter (CF) 2d both of which are interposed between the transparent substrates 2a, 2b. The liquid crystal panel 2 is provided further with a plurality of pixels, and thus the liquid crystal panel 2 is configured to be capable of displaying information such as characters and images of a full-color image by use of illumination light from the backlight device 3. Further, in the liquid crystal panel 2, as detailed below, a plurality of display areas are set on a screen.

The backlight device 3 includes an optical sheet group 5, a diffuser 6 and a LED substrate 7 on which LED units 8 each including light-emitting diodes of three colors of red (R), green (G) and blue (B) are provided. The optical sheet group 5 includes for example a polarizing sheet and a prism (focusing) sheet. These optical sheets serve to raise suitably the luminance of the illumination light from the backlight device 3, thereby improving the display performance of the liquid crystal panel 2.

In the backlight device 3, a plurality of LED substrates 7 are placed in matrix, and a plurality of LED units 8 are placed on each of the LED substrates 7. Further the backlight device 3 has a plurality of illumination areas for allowing the lights from the light-emitting diodes as the light sources to enter a plurality of display areas provided on the liquid crystal panel 2, respectively, and thus an area active backlight drive for lighting the light-emitting diodes for every illumination area is carried out.

Here, the LED substrate 7 and the LED unit 8 of the present embodiment will be described specifically with reference to FIGS. 2-4.

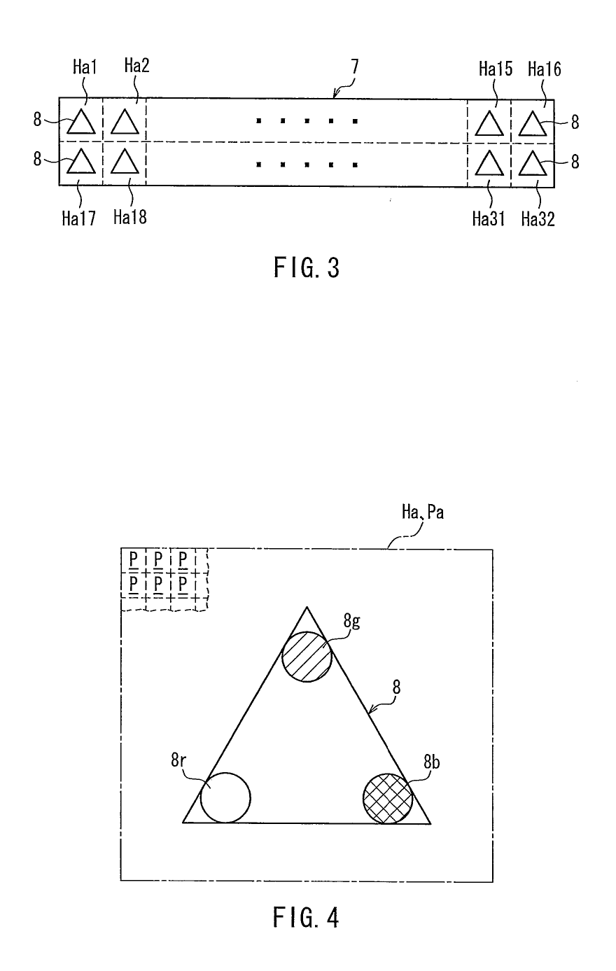

FIG. 2 is a plan view showing configuration of a LED substrate of the backlight device as shown in FIG. 1, and FIG. 3 is a plan view showing an arrangement example of the LED unit on the LED substrate as shown in FIG. 2. FIG. 4 is a plan view showing an example of a configuration of the LED unit as shown in FIG. 3.

As illustrated in FIG. 2, 2×8 (16 in total) LED substrates 7(1), 7(2) . . . 7(15), 7(16) (hereinafter, referred to as “7”) are placed on the backlight device 3. Each of the LED substrates 7 is divided into 2×16 (32 in total) regions as shown in FIG. 3, and the LED unit 8 is mounted on each of the regions. The thirty-two regions respectively configure the illumination areas Ha1, Ha2, . . . Ha31, Ha32 (hereinafter referred to as “Ha”) that are set on the backlight device 3.

In FIG. 3, the respective illumination areas Ha are divided from each other with longitudinal and transverse lines for clarity, but the respective areas Ha are not divided actually with any border lines or partitions. However, it is also possible for example to provide partitions on the LED substrate 7 so as to divide the respective illumination areas Ha from each other.

As illustrated in FIG. 4, on each of the illumination areas Ha, a LED unit 8 having light-emitting diodes 8r, 8g, 8b arranged on vertexes of a triangle is provided. The respective illumination areas Ha are provided to correspond to the display areas Pa each established on the screen of the liquid crystal panel 2 so as to allow light from the LED unit 8 to enter a plurality of pixels P each included in the display areas Pa. On the screen, for example 1920×1080 pixels are provided, and one display area Pa includes 4050 (=1920×1080÷512 (=16×32)) pixels.

The respective light-emitting diodes 8r, 8g and 8b compose light sources, and these light-emitting diodes 8r, 8g and 8b are to emit red light, green light and blue light respectively to the corresponding display areas Pa. The light-emitting diodes 8r, 8g and 8b have offset luminances that are set independently from each other, and the light-emitting diodes are configured to improve the color reproducibility of the image displayed on the screen, thereby improving the display quality (this will be described below in detail).

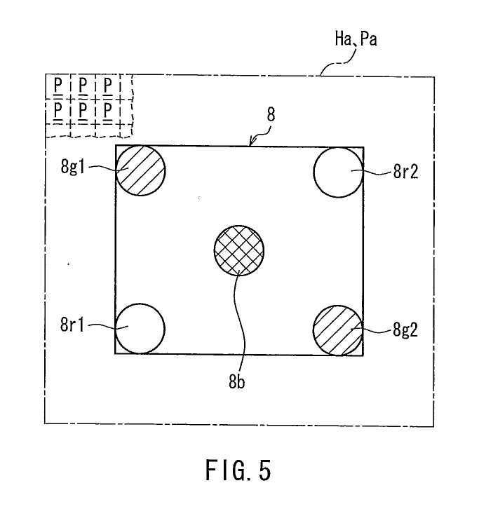

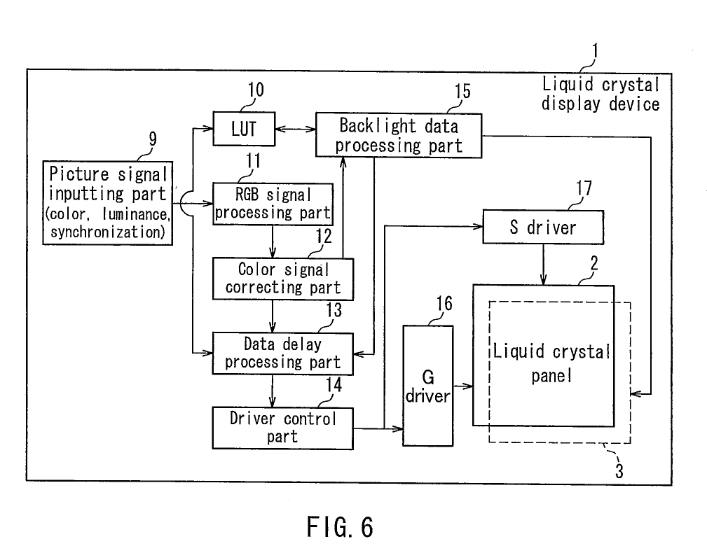

It should be noted that the configuration of the LED unit 8 in the present embodiment is not limited to that as shown in FIG. 4. As illustrated in FIG. 5, in an alterative example taking the light emitting efficiency of the RGB light-emitting diodes into consideration, a LED unit 8 that includes one blue light-emitting diode 8b and respectively two red and green light-emitting diode 8r1, 8r2 and 8g1, 8g2 may be used, or a white light-emitting diode may be used.

Irrespective of the above description of a case of using the LED substrates 7, placement of the LED substrates 7 can be avoided for example by arranging directly the LED units on the inner surface of the package 4. Alternatively, it is also possible to modify the number of the LED substrates 7 and LED units 8 to be placed respectively, or to set the illumination areas Ha and the display areas Pa at a ratio other than 1:1.

The number of the divided LED units 8 is not limited to the above-described 16×32, but it can be 10×20 for example.

However, if the number of the light-emitting diodes is extremely small with respect to the size of the liquid crystal panel 2, it will be impossible to prevent unevenness in the luminance distribution, which is caused by lack of quantity of light onto the screen, unevenness in the LED characteristics and increase in the optical distance to an adjacent LED unit. When taking this into consideration, for example, it is preferable that at least 500 LED units 8 are placed with respect to a liquid crystal panel 2 of about 40 to about 70 inches.

Hereinafter, the control part that controls the drives of the respective parts of the liquid crystal display device 1 of the present embodiment will be specified with reference to FIGS. 6 to 8.

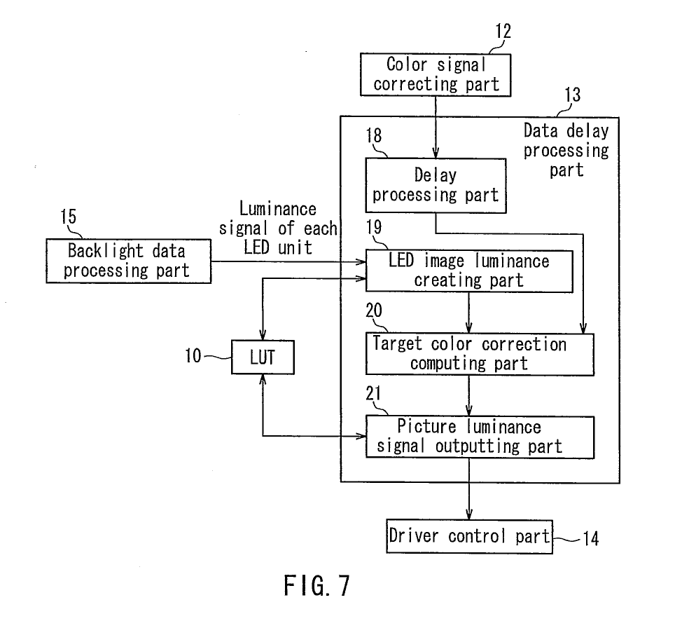

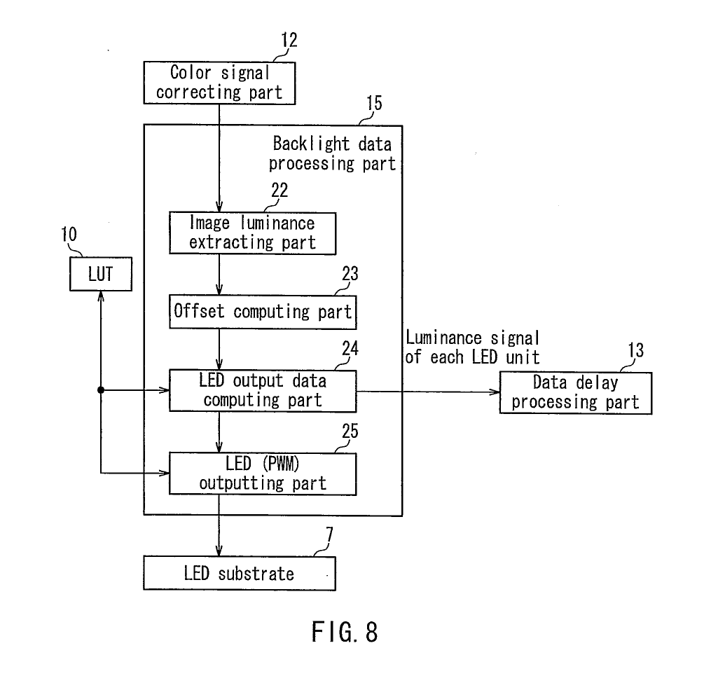

FIG. 6 is a block diagram showing a configuration of main components of the liquid crystal display device. FIG. 7 is a block diagram showing a configuration of a data delay processing part as shown in FIG. 6, and FIG. 8 is a block diagram showing a configuration of a backlight data processing part as shown in FIG. 6.

As shown in FIG. 6, the liquid crystal display device 1 is provided with a picture signal inputting part 9 that receives and processes a picture signal inputted from the exterior, a LUT (Look-Up Table) 10 that previously stores certain data, and an RGB signal processing part 11 that is connected to the picture signal inputting part 9. In the liquid crystal display device 1, a color signal correcting part 12, a data delay processing part 13, a driver control part 14 all of which are connected sequentially to the RGB signal processing part 11, a backlight data processing part 15 connected between the color signal correcting part 12 and the data delay processing part 13, and a G (gate) driver 16 and a S (source) driver 17 that are connected to the driver control part 14, are provided. In the liquid crystal display device 1, the driver control part 14 outputs instruction signals to the G driver 16 and to the S driver 17 depending on the picture signal inputted to the picture signal inputting part 9, thereby the liquid crystal panel 2 is driven per pixel, and the backlight data processing part 15 outputs an instruction signal to the backlight device 3, thereby the respective light-emitting diodes 8r, 8g and 8b of the LED unit 8 are driven for lighting.

To the picture signal inputting part 9, a composite picture signal is inputted from an antenna or the like (not shown), and the composite picture signal contains a color signal that indicates a color on a displayed image, a luminance signal that indicates luminance per pixel, a synchronization signal and the like. At the RGB signal processing part 11, the composite picture signal from the picture signal inputting part 9 is subjected to a chroma-process, a matrix-conversion process or the like to be converted to an RGB separate signal, and the RGB signal processing part 11 outputs the thus converted RGB separate signal to the color signal correcting part 12.

At the color signal correcting part 12, the RGB separate signal is subjected to predetermined correction processes that are specified on the basis of the color reproduction range and the display mode or the like on the liquid crystal panel 2, so as to be converted to a corrected picture signal (R′G′B′ separate signal). More specifically, to the color signal correcting part 12, a measurement result of the external light intensity (quantity of light) is inputted from a photosensor (not shown) provided to the liquid crystal display device 1, and the color signal correcting part 12 calculates the change in the color reproduction range caused by the influence of external light on the liquid crystal panel 2 by using the measurement result, and carries out a color conversion process to provide an optimal display color under the external light condition.

The color signal correcting part 12 is configured to read out a color signal of a particular color such as a human skin color and correct the signal value to that of a color preferred by a user, or to raise or lower the luminance of the entire surface of screen in accordance with the display mode inputted from a remote controller or the like attached to the liquid crystal display device 1. And the color signal correcting part 12 subjects the R′G′B′ separate signal to a γ process (linearization) with reference to γ data of the LUT 10, and subsequently outputs the signal to the data delay processing part 13 and to the backlight data processing part 15 per frame (displayed image).

The data delay processing part 13 is a processing part that delays data of an instruction signal outputted to the liquid crystal panel 2 side for the purpose of matching the operation timing of the liquid crystal panel 2 and the operation timing of the backlight device 3, and the data delay processing part 13 is composed of ASIC (Application Specific Integrated Circuit) for example.

Specifically, the data delay processing part 13 is provided with a delay processing part 18, a LED image luminance creating part 19, a target color correction computing part 20 and a picture luminance signal outputting part 21 as shown in FIG. 7. The R′G′B′ separate signal (picture signal) from the color signal correcting part 12 is inputted to the delay processing part 18, and the picture signal is delayed for a predetermined time so as to carry out substantially the above-described data delay process.

Into the LED image luminance creating part 19, luminance signals of the respective LED units 8 from the backlight data processing part 15 are to be inputted. In the luminance signals of the respective LED units 8, luminance values of the respective light-emitting diodes (light sources) 8r, 8g and 8b included in the corresponding LED unit 8 are instructed. Further, the LED image luminance creating part 19 acquires PSF (Point Spread Function) data from the LUT 10 with respect to the inputted luminance signal of the LED unit 8. And then, the LED image luminance creating part 19 calculates a LED luminance value in light of the PSF data, by using the instructed luminance values of the respective light-emitting diodes 8r, 8g and 8b and the thus acquired PSF data, namely, it calculates gradation signal data of the respective light-emitting diodes 8r, 8g, 8b corresponding to all of the pixels (for example, 1920×1080 pixels), and outputs the data to the target color correction computing part 20.

The above-described PSF data are the values obtained by measuring or calculating the spread of light that comes from the respective light-emitting diodes (light sources) 8r, 8g, 8b and that is visually observed through the liquid crystal panel 2 including the optical sheet group 5 and the like, and the data have been stored previously in the LUT 10. By using the PSF data, information can be displayed on the liquid crystal panel 2 with a more suitable luminance, and thus the display quality can be improved further. Further, the γ data, the gradation property data (linearity) of the light-emitting diodes 8r, 8g, 8b and the like are stored in the LUT 10.

The target color correction computing part 20 composes a color correction computing part that corrects an inputted picture signal by use of a predetermined CF property of the color filter 2d. Specifically, the R′G′B′ separate signal (picture signal) from the delay processing part 18 and the gradation signal data from the LED image luminance creating part 19 are to be inputted to the target color correction computing part 20. And in the target color correction computing part 20, a R″G″B″ picture luminance signal to be outputted from the LCD driver side is to be obtained by dividing the R′G′B′ separate signal (numerator) of each pixel with the gradation signal data (denominator) of the light-emitting diodes 8r, 8g, 8b corresponding to the pixel.

In an alternative configuration, the target color correction computing part 20 performs for example the correction calculation stated below and further corrects the thus calculated R″G″B″ picture luminance signal. Namely, from the luminance values of the light-emitting diodes 8r, 8g, 8b of the LED unit 8 which have been determined on receiving the R′G′B′ separate signal, the target color correction computing part 20 calculates tristimulus values XYZ (color reproduction space that can be represented with pixels from the light emitting condition of the backlight device 3) of the respective colors that have transmitted the respective RGB-CF. Further, it is possible to obtain a corrected R″G″B″ picture luminance signal by multiplying the 3×3 inverse matrix and the target colors (Xt, Yt, Zt) obtained by multiplying the R′G′B′ separate signal by the 3×3 matrix of the target color reproduction space XYZ. By performing such a correction calculation, the target color that is to be displayed as an image by the R′G′B′ separate signal can be matched substantially perfectly with the color that is displayed actually.

A picture luminance signal outputting part 21 acquires from the LUT 10 the γ data (white temperature data with respect to gradation) with respect to the corrected R″G″B″ picture luminance signal from the target color correction computing part 20 and carries out a y gradation correction. And the picture luminance signal outputting part 21 outputs a picture luminance signal to the driver control part 14.

In the present embodiment, it is assumed by taking a TV broadcast signal into consideration, that the picture signal entering through the picture signal inputting part 9 is subjected to an inverse y process and inputted. Therefor, if a picture signal of TV or the like entering through the picture signal inputting part 9 is inputted with a linear gradation, the y process as described in the present embodiment may be omitted.

The driver control part 14 generates instruction signals by using the picture luminance signal from the picture luminance signal outputting part 21, and outputs the respective instruction signals to the G driver 16 and the S driver 17. A plurality of gate lines (not shown) and a plurality of signal lines (not shown) provided on the liquid crystal panel 2 are connected respectively to the G driver 16 and the S driver 17. The G driver 16 and the S driver 17 output respectively a gate signal and a source signal to the gate lines and to the source lines in accordance with the instruction signals from the driver control part 14, thereby the liquid crystal panel 2 is driven per pixel and thus an image is displayed on the screen.

The LED image luminance creating part 19, the target color correction computing part 20, the picture luminance signal outputting part 21 and the driver control part 14 compose a display control part that corrects the inputted picture signal by using the luminance value for each of the light sources (light-emitting diodes) from the below-mentioned backlight control part (backlight data processing part), and controls the drive of the display part (liquid crystal panel) per pixel with reference to the corrected picture signal.

Although the above explanation refers to a case where the LED image luminance creating part 19, the target color correction computing part 20 and the picture luminance signal outputting part 21 are placed inside the data delay processing part 13, the present embodiment is not limited to this example. It is possible for example that the delay processing part 18 is provided separately, and further that the LED image luminance creating part 19, the target color correction computing part 20 and the picture luminance signal outputting part 21 are provided integrally with the driver controlling part 14, thereby forming a display control part.

As shown in FIG. 6, the backlight data processing part 15 is connected to the color signal correcting part 12, so that a R′G′B′ separate signal (picture signal) is to be inputted into the backlight data processing part 15. For the backlight data processing part 15, ASIC is used for example. The backlight data processing part 15 composes a backlight control part that uses the inputted picture signals so as to determine the luminance value of light emitted from each of the plural illumination areas Ha onto a corresponding display area Pa for each light source (light-emitting diode), thereby controlling the drive of the backlight part (backlight device). Namely, the backlight data processing part 15 is configured to output the PWM signal values of the respective light-emitting diodes 8r, 8g, 8b to the LED substrate 7, with respect to the inputted picture signal with reference to the LUT 10.

Specifically, as shown in FIG. 8, an image luminance extracting part 22, an offset computing part 23, a LED output data computing part 24 and a LED (PWM) outputting part 25, which are connected sequentially to the color signal correcting part 12, are provided to the backlight data processing part 15.

With reference to the R′G′B′ image signal, the image luminance extracting part 22 extracts the maximal luminance value for each color of RGB of the displayed image at each of the display areas Pa. Namely, the image luminance extracting part 22 extracts from the R′G′B′ image signal the maximal values of the R′G′B′ luminance signals on the display areas Pa corresponding to the respective illumination areas Ha, and outputs to the offset computing part 23 the values as the reference values of the luminance values for the light-emitting diodes 8r, 8g, 8b on the corresponding illumination areas Ha.

The present invention is not limited to the above example. Also it is possible that the image luminance extracting part 22 calculates the luminance average values of the respective colors of RGB in the corresponding illumination areas Ha for the respective display areas Pa on the basis of the R′G′B′ image signal so as to obtain the reference instruction values of the luminance values of the light-emitting diodes 8r, 8g, 8b in the illumination areas Ha. Further, the image luminance extracting part 22 may mix and average both the luminance maximal values and the luminance average values and outputs the values as the reference instruction values to the offset computing part 23. It should be noted however that the luminance maximal values are used preferably for the reference instruction values since the displayed image will have a peak luminance more easily.

In a case where a picture inputted from the exterior includes noise, at the time of extracting the maximal value of the R′G′B′ luminance signal of the display area Pa, a noise signal (for example, the maximal luminance signal value) may be picked up and thus the accurate maximal value of the luminance signal cannot be extracted. Therefore, in an alternative method for eliminating (relieving) noise signal, for example, it is possible to divide the pixels in the display area Pa into groups each composed of twenty pixels, which is then averaged to obtain a maximal value that will make the maximal value of the R′G′B′ luminance value in the display area Pa.

The offset computing part 23 is configured to carry out a weighting process for every color of RGB with respect to the maximal value of the R′G′B′ luminance signal from the image luminance extracting part 22, and thus to compute the luminance signals of the light-emitting diodes 8r, 8g, 8b of each of the LED units 8 independently from each other. Namely, since the offset luminances of the light-emitting diodes 8r, 8g, 8b are set independently from each other, the offset luminance computing part 23 can carry out a weighting process for every color of RGB by using the predetermined CF property of the color filter 2d and the predetermined light-emitting property of the light-emitting diodes 8r, 8g, 8b, thereby obtaining suitably the luminance signals of the light-emitting diodes 8r, 8g, 8b (the details will be described below).

The offset luminance computing part 23 further composes a luminance determining part that corrects and determines the luminance value determined for each light source, by use of a correction coefficient predetermined on the basis of the predetermined CF property of the color filter 2d and the predetermined light-emitting property of the light-emitting diodes 8r, 8g, 8b (light sources).

The LED output data computing part 24 is configured to carry out a predetermined computation with respect to the luminance signals of the light-emitting diodes 8r, 8g, 8b of each of the LED units 8 from the offset computing part 23. Specifically, the LED output data computing part 24 corrects the luminance signals of the respective LEDs of RGB determined at the offset computing part 23 so that the luminance balance between each of the LED unit 8 and a surrounding LED unit 8 (namely, an adjacent illumination area Ha) will be within a predetermined balance range, and further that the consistency with the previous frame (namely, the previous display action on the liquid crystal panel (display part) 2) will be ensured. Thereby, it is possible to prevent a large luminance change from occurring between each of the display areas Pa and the ambient display areas Pa, and prevent a considerable increase in the luminance change from the display action of the previous frame (displayed image), and thus the display quality of the liquid crystal display device 1 can be improved.

The LED output data computing part 24 uses the value of the minimal offset luminance (for example, 1% of the maximal luminance that can be emitted by the LED) previously stored in the LUT 10, so that the R″G″B″ picture luminance signal can be obtained surely at the target color correction computing part 20 as described above. Namely, the LED output data computing part 24 acquires the value of the minimal offset luminance of a corresponding color from the LUT 10, and in a case where the value of the gradation signal data of any of the light-emitting diodes 8r, 8g, 8b is smaller than the minimal offset luminance, the luminance value of the light-emitting diode smaller than the minimal offset luminance is replaced by the thus acquired value.

As a result of the above-mentioned replacement, when performing the above-mentioned division with denominators of the luminance values (gradation signal data) of the light-emitting diodes 8r, 8g, 8b at the target color correction computing part 20, deficient accuracy or errors caused by the use of “0” or the neighbor value may be avoided. At the same time, subtle characteristic variations of the power supply capacities of the LED illumination and the LED substrate may be avoided. As a result, it is possible to calculate surely the R″G″B″ picture luminescence signal at the target color correction computing part 20.

It is preferable that the value of the minimal offset luminance is not raised too much. For example, it is preferably set to about 0.1% to 10% of the available maximal luminance as described above.

The LED output data computing part 24 outputs the luminance signals of each of the LED units 8 after the correction computing, to the LED (PWM) outputting part 25 and to the data delay processing part 13.

The LED (PWM) outputting part 25 generates a PWM signal to drive the respective light-emitting diodes 8r, 8g, 8b of the corresponding LED unit 8, by using the luminance signal of each LED unit 8 from the LED output data computing part 24 and the PWM control data from the LUT 10, and outputs the PWM signal to the corresponding LED substrate 7. Thereby, on the LED substrate 7, the respective light-emitting diodes 8r, 8g, 8b are allowed to emit light corresponding to the PWM signal.

The above explanation refers to a case where the respective light-emitting diodes 8r, 8g, 8b are driven by the PWM dimmer using the PWM signal, but the present embodiment is not limited to this example. In an alternative example, the respective light-emitting diodes 8r, 8g, 8b are driven by using a current dimming (here, this refers to a gradation control system to fluctuate the LED current value with an input gradation signal). However, the PWM dimmer is preferable to the current dimming, as described above. Namely, the color temperature of the LED has a dependency on the operation current, and thus it is required to drive the LED by using the PWM signal so as to suppress the color change for the purpose of maintaining the faithful color reproduction while obtaining a desired luminance.

In addition to the above-described components, the LED (PWM) outputting part 25 can be provided with a component for correcting the luminance signal from the LED output data computing part 24 by using the results detected with a sensing means such as a temperature sensor or a timer provided to the liquid crystal display device 1. Namely, the LED (PWM) outputting part 25 can have additional functions. For example, the LED (PWM) outputting part 25 uses the detection result from the temperature sensor so as to rectify the change in the luminous efficiency of the respective light-emitting diodes 8r, 8g, 8b, which is caused by the change in the ambient temperature. Or the LED (PWM) outputting part 25 uses the measurement result in the lighting time from the timer so as to rectify the change in the luminous efficiency, color change or the like of the respective light-emitting diodes 8r, 8g, 8b, which are caused by aging.

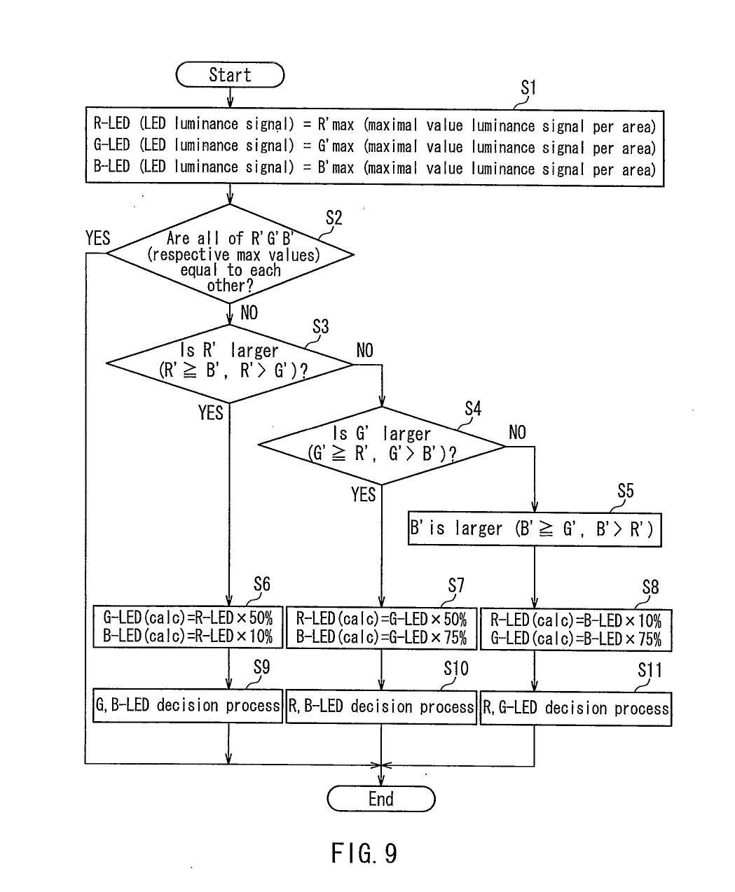

Here, the operations of the liquid crystal display device 1 of the present embodiment will be described below with reference to FIGS. 9-12. The explanation below mainly refers to the processes at the offset computing part 23.

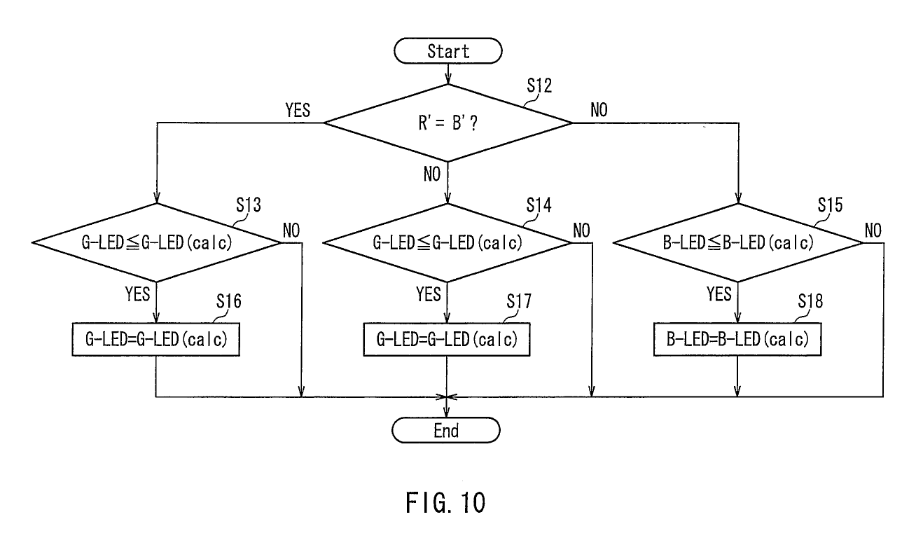

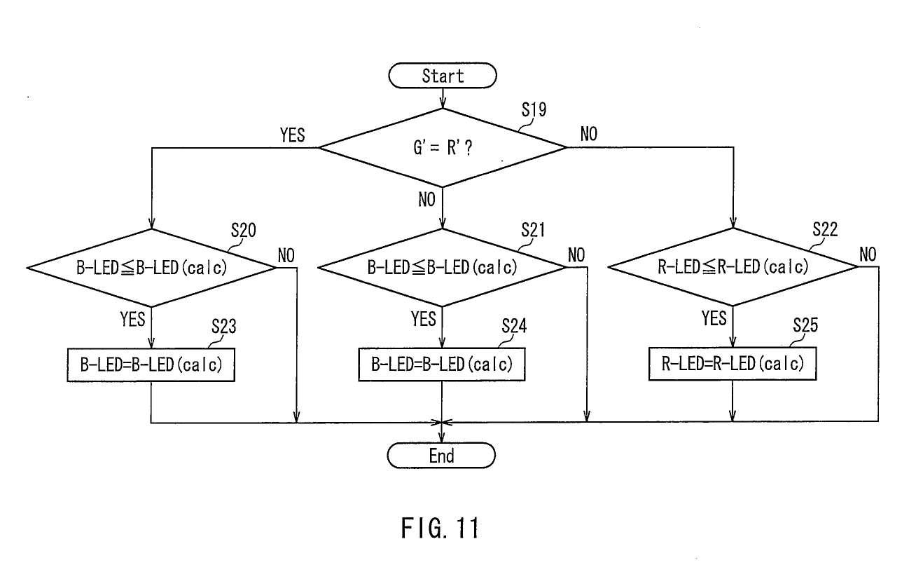

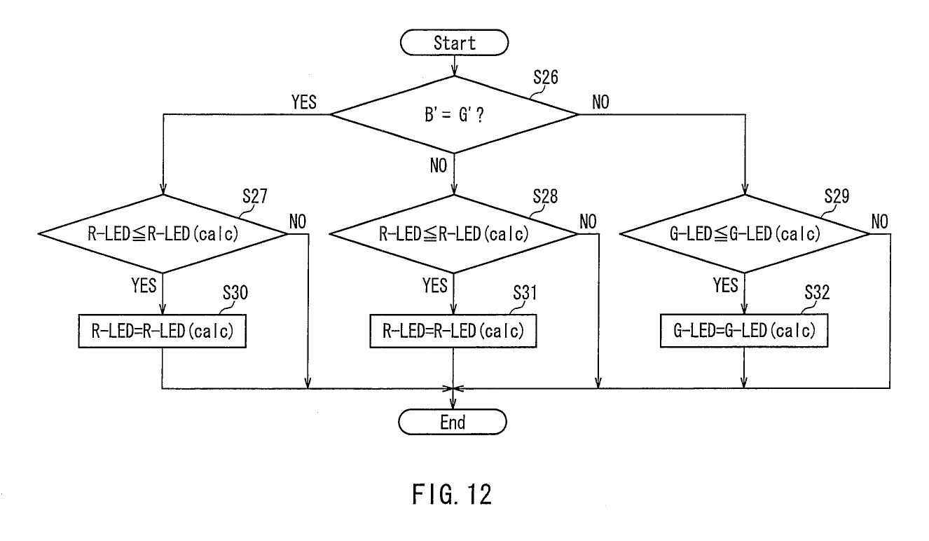

FIG. 9 is a flow chart showing the operations of the offset computing part as shown in FIG. 8, and FIG. 10 is a flow chart showing the detail operations of the G,B-LED decision process as shown in FIG. 9. FIG. 11 is a flow chart showing the detail operations of the R,B-LED decision process as shown in FIG. 9, and FIG. 12 is a flow chart showing the detail operations of the R,G-LED decision process as shown in FIG. 9.

As indicated in step S1 of FIG. 9, the offset computing part 23 sets, in each of the LED units 8 (each illumination area Ha), the respective luminance maximal values of R′G′B′ from the image luminance extracting part 22 as the luminance signal values of the corresponding light-emitting diodes 8r, 8g, 8b of the LED unit 8. Namely, at each of the LED units 8, the LED luminance signals (normalized values from 0 to 1) of the light-emitting diodes 8r, 8g, 8b are set as R-LED, G-LED and B-LED respectively, and, among the image data R′G′B′ (information on respective luminances of RGB inside the display area Pa) of the pixels (4050 pixels) included in the display area Ha covered by each of the LED units 8, signals expressing the maximal luminance values are set as the maximal value luminance signals R′max, G′max, B′max (normalized to values of 0 to 1). In such a case, the offset computing part 23 sets the luminance signal values (offset values) of the light-emitting diodes 8r, 8g, 8b as the values of R′max, G′max, B′max respectively at each of the LED units 8.

Next, the offset computing part 23 decides whether all of the luminance signal values (values of R′max, G′max and B′max) of the light-emitting diodes 8r, 8g, 8b are equal or not. And when all values are decided as equal, the offset computing part 23 outputs the luminance signal values of the light-emitting diodes 8r, 8g, 8b, as the respective luminance signals of RGB of the corresponding LED unit 8 to the LED output data computing part 24, without carrying out a weighting process.

In a case where it is decided in the step S2 that all of the luminance signal values of the light-emitting diodes 8r, 8g, 8b are not equal, the offset computing part 23 decides the magnitude correlation of these luminance signal values and carries out a weighting process corresponding to the decision.

Specifically, as shown in the step S3, the offset computing part 23 decides whether the luminance signal value of the light-emitting diode 8r is equal to or larger than the luminance signal value of the light-emitting diode 8b and larger than the luminance signal value of the light-emitting diode 8g. When it is decided that the luminance signal value of the light-emitting diode 8r does not meet the condition in the step S3, the offset computing part 23 decides whether the luminance signal value of the light-emitting diode 8g is equal to or larger than the luminance signal value of the light-emitting diode 8r and larger than the luminance signal value of the light-emitting diode 8b (step S4). Further, when it is decided that the luminance signal value of the light-emitting diode 8g does not meet the condition in step S4, the offset computing part 23 decides whether the luminance signal value of the light-emitting diode 8b is equal to or larger than the luminance signal value of the light-emitting diode 8g and larger than the luminance signal value of the light-emitting diode 8r (step S5).

In the step S3, when it is decided that the luminance signal value of the light-emitting diode 8r is equal to or larger than the luminance signal value of the light-emitting diode 8b and larger than the luminance signal value of the light-emitting diode 8g, the offset computing part 23 executes a weighting process using a predetermined correction coefficient (percentage (%)) so as to calculate the respective weighted luminance signal values of the light-emitting diodes 8g, 8b (step S6).

Namely, the offset computing part 23 acquires values of 50% and 10% stored respectively on a memory (not shown) as correction coefficients for the light-emitting diodes 8g, 8b. And the offset computing part 23 calculates a value obtained by multiplying the luminance signal value of the light-emitting diode 8r by 50% as the weighted luminance signal value (G-LED(calc)) of the light-emitting diode 8g, and also calculates a value obtained by multiplying the luminance signal value of the light-emitting diode 8r by 10% as the weighted luminance signal value (B-LED(calc)) of the light-emitting diode 8b.

In the above-described step S4, when it is decided that the luminance signal value of the light-emitting diode 8g is equal to or larger than the luminance signal value of the light-emitting diode 8r and larger than the luminance signal value of the light-emitting diode 8b, the offset computing part 23 executes a weighting process using a predetermined correction coefficient so as to calculate the respective weighted luminance signal values of the light-emitting diodes 8r, 8b (step S7).

Namely, the offset computing part 23 acquires values of 50% and 75% stored respectively on the memory as correction coefficients for the light-emitting diodes 8r, 8b. And the offset computing part 23 calculates a value obtained by multiplying the luminance signal value of the light-emitting diode 8g by 50% as the weighted luminance signal value (R-LED(calc)) of the light-emitting diode 8r, and also calculates a value obtained by multiplying the luminance signal value of the light-emitting diode 8g by 75% as the weighted luminance signal value (B-LED(calc)) of the light-emitting diode 8b.

In the above-described step S5, when it is decided that the luminance signal value of the light-emitting diode 8b is equal to or larger than the luminance signal value of the light-emitting diode 8g and larger than the luminance signal value of the light-emitting diode 8r, the offset computing part 23 executes a weighting process using a predetermined correction coefficient so as to calculate the respective weighted luminance signal values of the light-emitting diodes 8r, 8g (step S8).

Namely, the offset computing part 23 acquires values of 10% and 75% stored respectively on the memory as correction coefficients for the light-emitting diodes 8r, 8g. And the offset computing part 23 calculates a value obtained by multiplying the luminance signal value of the light-emitting diode 8b by 10% as the weighted luminance signal value (R-LED(calc)) of the light-emitting diode 8r, and also calculates a value obtained by multiplying the luminance signal value of the light-emitting diode 8b by 75% as the weighted luminance signal value (G-LED(calc)) of the light-emitting diode 8g.

As described above, in the steps S6-S8, weighting processes are carried out by adding up the predetermined correction coefficient with respect to the offset values of the light-emitting diodes 8r, 8g, 8b as determined respectively in the step S1. The correction coefficients are determined previously by using the predetermined CF property of the color filter 2d and the predetermined luminescence property of the light-emitting diodes 8r, 8g, 8b.

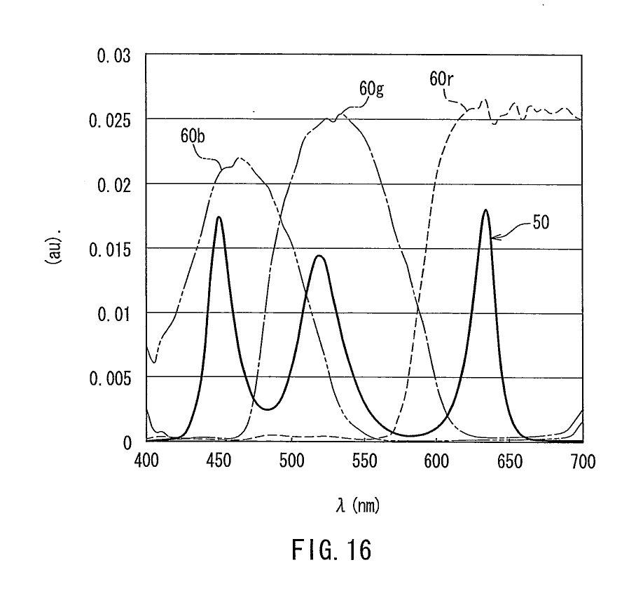

Specifically, the respective correction coefficients are determined by driving the commercialized liquid crystal display device 1 for performing subjective evaluations and measurement so that the influences of color displacement of the displayed image are suppressed and a vivid image is displayed in comparison with a case of the monochrome area active drive. Alternatively, the respective correction coefficients can be determined by performing a simulation or the like of the display operation by using the data of the transmission wavelength of the respective color filters of RGB as indicated with curves 60r, 60g, 60b in FIG. 16 and/or the data of the emission wavelengths of the respective light-emitting diodes of RGB as indicated with a curve 50 in FIG. 16.

The correction coefficients indicated in the steps S6-S8 are not limited to the above-described numerical values, but the values of the respective percentages (%) can be decreased or the values of the respective percentages (%) can be equalized to approach a common value so as to lower the color reproduction range a little in a case where there is a necessity of lowering the reference value of the color displacement for example, namely, a necessity of improving the color reproduction range even when a picture of a bad condition with a color displacement is observed.

Next, when any of the processing operations of the above steps S6-S8 ends, the offset computing part 23 compares the respective weighted luminance signal values of the light-emitting diodes 8r, 8g, 8b determined in the steps S6-S8 with the corresponding values of R′max, G′max and B′max obtained in the step S1, thereby decides whether the respective weighted luminance signal values are appropriate or not and determines the respective final luminance signal values of the light-emitting diodes 8r, 8g, 8b.

Specifically, when the processing operation in the step S6 ends, the offset computing part 23 executes the G,B-LED decision process (step S9) for deciding whether the respective weighted luminance signal values of the light-emitting diodes 8g, 8b determined in the step S6 are appropriate or not, thereby determines the respective final luminance signal values of the light-emitting diodes 8r, 8g, 8b to be outputted to the LED output data computing part 24.

More specifically, as shown in step S12 in FIG. 10, the offset computing part 23 decides whether the LED luminance signals (i.e., R′max, B′max) of the light-emitting diodes 8r, 8b determined in the step S1 are equal to each other or not. When deciding that the values of the LED luminance values of these light-emitting diodes 8r, 8b are equal to each other, the offset computing part 23 sets the values of these LED luminance signals as the respective final luminance signal values of the light-emitting diodes 8r, 8b. Subsequently, the offset computing part 23 compares the value of the LED luminance signal (i.e., G′max) of the light-emitting diode 8g determined in the step S1 and the luminance signal value of the light-emitting diode 8g (i.e., (G-LED(calc)) that has been weighted in the step S6 (step S13).

When deciding that the weighted luminance signal value of the light-emitting diode 8g is equal to or larger than the value of G′max, the offset computing part 23 uses the weighted luminance signal value of the light-emitting diode 8g as the final luminance signal value of the light-emitting diode 8g (step S16).

In the step S13, when the weighted luminance signal value of the light-emitting diode 8g is decided as smaller than the value of G′max, the offset computing part 23 sets the value of G′max as the final luminance signal value of the light-emitting diode 8g.

In the step S12, when it is decided that the value of R′max is larger than the value of B′max, the offset computing part 23 carries out the processes of steps S14-S18 so as to determine the respective final luminance signal values of the light-emitting diodes 8g, 8b. And the offset computing part 23 uses the value of R′max for the final luminance signal value of the light-emitting diode 8r.

Namely, as shown in the step S14, the offset computing part 23 compares the value of LED luminance signal of the light-emitting diode 8g determined in the step S1 (i.e., G′max) and the luminance signal value of the light-emitting diode 8g which has been weighted in the step S6 (i.e., G-LED(calc)).

And when deciding that the weighted luminance signal value of the light-emitting diode 8g is equal to or larger than the value of G′max, the offset computing part 23 uses, as the final luminance signal value of the light-emitting diode 8g, the weighted luminance signal value of the light-emitting diode 8g (step S17).

In the step S14, when it is decided that the weighted luminance signal value of the light-emitting diode 8g is smaller than the value of G′max, the offset computing part 23 sets the value of G′max as the final luminance signal value of the light-emitting diode 8g.

Further, as shown in the step S15, the offset computing part 23 compares the value of LED luminance signal of the light-emitting diode 8b determined in the step S1 (i.e., B′max) and the luminance signal value of the light-emitting diode 8b which has been weighted in the step S6 (i.e., B-LED(calc)).

And when deciding that the weighted luminance signal value of the light-emitting diode 8b is equal to or larger than the value of B′max, the offset computing part 23 uses, as the final luminance signal value of the light-emitting diode 8b, the weighted luminance signal value of the light-emitting diode 8b (step S18).

In the step S15, when it is decided that the weighted luminance signal value of the light-emitting diode 8b is smaller than the value of B′max, the offset computing part 23 sets the value of B′max as the final luminance signal value of the light-emitting diode 8b.

Returning to FIG. 9, when the processing operation in the above-mentioned step S7 ends, the offset computing part 23 executes R,B-LED decision process for deciding whether the respective weighted luminance signal values of the light-emitting diodes 8r, 8b determined in the step S7 are appropriate or not (step S10), and determines the respective final luminance signal values of the light-emitting diodes 8r, 8g, 8b to be outputted to the LED output data computing part 24.

Specifically speaking, as shown in the step S19 in FIG. 11, the offset computing part 23 decides whether the LED luminance signals of the light-emitting diodes 8r, 8g determined in the step S1 (i.e., R′max, G′max) are equal to each other or not. When deciding that the LED luminance signals of the light-emitting diodes 8r, 8g are equal to each other, the offset computing part 23 sets the values of the LED luminance signals as the respective final luminance signal values of the light-emitting diodes 8r, 8g. Subsequently, the offset computing part 23 compares the value of the LED luminance signal (i.e., B′max) of the light-emitting diode 8b determined in the step S1 and the luminance signal value of the light-emitting diode 8b (i.e., (B-LED(calc)) that has been weighted in the step S7 (step S20).

When deciding that the weighted luminance signal value of the light-emitting diode 8b is equal to or larger than the value of B′max, the offset computing part 23 uses, as the final luminance signal value of the light-emitting diode 8b, the weighted luminance signal value of the light-emitting diode 8b (step S23).

In the step S20, when it is decided that the weighted luminance signal value of the light-emitting diode 8b is smaller than the value of B′max, the offset computing part 23 sets the value of B′max as the final luminance signal value of the light-emitting diode 8b.

In the step S19, when it is decided that the value of G′max is larger than the value of R′max, the offset computing part 23 carries out the processes of steps S21-S25 so as to determine the respective final luminance signal values of the light-emitting diodes 8b, 8r. And the offset computing part 23 uses the value of G′max as the final luminance signal value of the light-emitting diode 8g.

Namely, as shown in step S21, the offset computing part 23 compares the value of LED luminance signal of the light-emitting diode 8b determined in the step S1 (i.e., B′max) and the luminance signal value of the light-emitting diode 8b which has been weighted in the step S7 (i.e., B-LED(calc)).

And when deciding that the weighted luminance signal value of the light-emitting diode 8b is equal to or larger than the value of B′max, the offset computing part 23 uses, as the final luminance signal value of the light-emitting diode 8b, the weighted luminance signal value of the light-emitting diode 8b (step S24).

In the step S21, when it is decided that the weighted luminance signal value of the light-emitting diode 8b is smaller than the value of B′max, the offset computing part 23 sets the value of B′max as the final luminance signal value of the light-emitting diode 8b.

Further, as shown in the step S22, the offset computing part 23 compares the value of LED luminance signal of the light-emitting diode 8r determined in the step S1 (i.e., R′max) and the luminance signal value of the light-emitting diode 8r which has been weighted in the step S7 (i.e., R-LED(calc)).

And when deciding that the weighted luminance signal value of the light-emitting diode 8r is equal to or larger than the value of R′max, the offset computing part 23 uses, as the final luminance signal value of the light-emitting diode 8r, the weighted luminance signal value of the light-emitting diode 8r (step S25).

In the step S22, when it is decided that the weighted luminance signal value of the light-emitting diode 8r is smaller than the value of R′max, the offset computing part 23 sets the value of R′max as the final luminance signal value of the light-emitting diode 8r.

Returning to FIG. 9, when the processing operation in the above-mentioned step S8 ends, the offset computing part 23 executes R,G-LED decision process for deciding whether the respective weighted luminance signal values of the light-emitting diodes 8r, 8g determined in the step S8 are appropriate or not (step S11), and determines the respective final luminance signal values of the light-emitting diodes 8r, 8g, 8b to be outputted to the LED output data computing part 24.

Specifically speaking, as shown in the step S26 in FIG. 12, the offset computing part 23 decides whether the LED luminance signals of the light-emitting diodes 8b, 8g determined in the step S1 (i.e., B′max, G′max) are equal to each other or not. When deciding that the LED luminance signals of the light-emitting diodes 8b, 8g are equal to each other, the offset computing part 23 sets the values of the LED luminance signals as the respective final luminance signal values of the light-emitting diodes 8b, 8g. Subsequently, the offset computing part 23 compares the value of the LED luminance signal (i.e., R′max) of the light-emitting diode 8r determined in the step S1 and the luminance signal value of the light-emitting diode 8r (i.e., (R-LED(calc)) which has been weighted in the step S8 (step S27).

When deciding that the weighted luminance signal value of the light-emitting diode 8r is equal to or larger than the value of R′max, the offset computing part 23 uses, as the final luminance signal value of the light-emitting diode 8r, the weighted luminance signal value of the light-emitting diode 8r (step S30).

In the step S27, when it is decided that the weighted luminance signal value of the light-emitting diode 8r is smaller than the value of R′max, the offset computing part 23 sets the value of R′max as the final luminance signal value of the light-emitting diode 8r.

In the step S26, when it is decided that the value of B′max is larger than the value of G′max, the offset computing part 23 carries out the processes of steps S28-S32 so as to determine the respective final luminance signal values of the light-emitting diodes 8r, 8g. And the offset computing part 23 uses the value of B′max as the final luminance signal value of the light-emitting diode 8b.

Namely, as shown in the step S28, the offset computing part 23 compares the value of LED luminance signal of the light-emitting diode 8r determined in the step S1 (i.e., R′max) and the luminance signal value of the light-emitting diode 8r which has been weighted in the step S8 (i.e., R-LED(calc)).

And when deciding that the weighted luminance signal value of the light-emitting diode 8r is equal to or larger than the value of R′max, the offset computing part 23 uses, as the final luminance signal value of the light-emitting diode 8r, the weighted luminance signal value of the light-emitting diode 8r (step S31).

In the step S28, when it is decided that the weighted luminance signal value of the light-emitting diode 8r is smaller than the value of R′max, the offset computing part 23 sets the value of R′max as the final luminance signal value of the light-emitting diode 8r.

Further, as shown in the step S29, the offset computing part 23 compares the value of LED luminance signal of the light-emitting diode 8g determined in the step S1 (i.e., G′max) and the luminance signal value of the light-emitting diode 8g which has been weighted in the step S8 (i.e., G-LED(calc)).

And when deciding that the weighted luminance signal value of the light-emitting diode 8g is equal to or larger than the value of G′max, the offset computing part 23 uses, as the final luminance signal value of the light-emitting diode 8g, the weighted luminance signal value of the light-emitting diode 8g (step S32).

In the step S29, when it is decided that the weighted luminance signal value of the light-emitting diode 8g is smaller than the value of G′max, the offset computing part 23 sets the value of G′max as the final luminance signal value of the light-emitting diode 8g.

In the thus configured liquid crystal display device 1 of the present embodiment, light-emitting diodes (light sources) 8r, 8g, 8b of RGB mixable with white light are provided to each of the plural illumination areas Ha. At the light-emitting diodes 8r, 8g, 8b, as indicated as R-LED(calc), G-LED(calc) and B-LED(calc) in the steps S6-S8, the offset luminances are set independently from each other. Thereby, the offset computing part (control part) 23 can control independently the offset luminances for the respective light-emitting diodes 8r, 8g, 8b. Namely, the operations for processing in the steps S6-S32 can be carried out, and in accordance with the inputted picture signals, the luminance values of the respective light-emitting diodes 8r, 8g, 8b can be determined suitably. As a result, unlikely to the conventional technique, the color reproducibility can be improved, and thus the display quality can be improved.

Further, in the liquid crystal display device 1 of the present embodiment, as indicated in the steps S6-S8 in FIG. 11, the offset computing part 23 corrects and determines the luminance values determined for the respective light-emitting diodes 8r, 8g, 8b, by using the correction coefficient that has been determined previously based on the predetermined CF property of the color filter 2d and also on the predetermined emission property of the light-emitting diodes 8r, 8g, 8b. Thereby, in the liquid crystal display device 1 of the present embodiment, it is possible to determine more suitably the respective luminance values of the light-emitting diodes 8r, 8g, 8b while suppressing occurrence of color displacement with respect to the inputted picture signal, thereby improving the color reproducibility on the displayed image and improving surely the display quality.

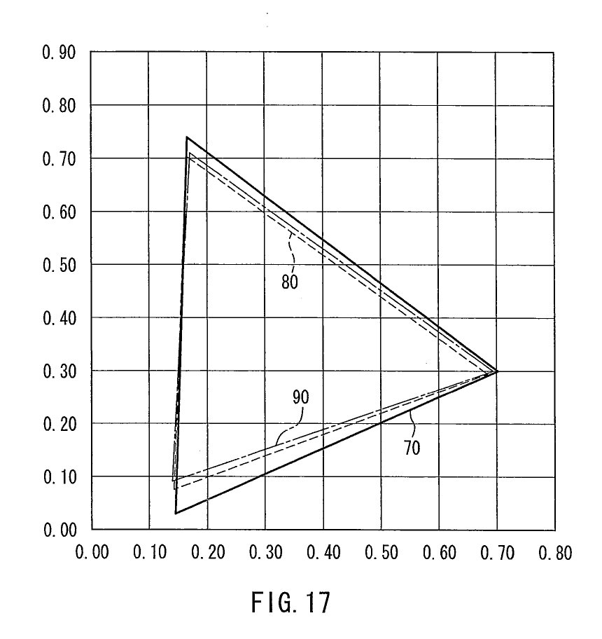

Specifically speaking, in the liquid crystal display device 1 of the present embodiment, the offset computing part 23 is configured to execute the weighting process as shown in the steps S6-S8, and by modifying the respective correction coefficients in the weighting processes, it is possible to adjust freely the color reproduction range of the liquid crystal display device 1 from the color reproduction range indicated with the solid line 70 in FIG. 17 to the color reproduction range indicated with the alternate long and short dash line 90 in FIG. 17.

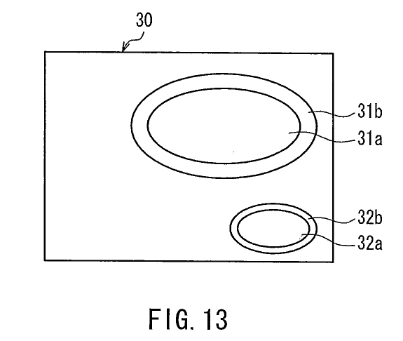

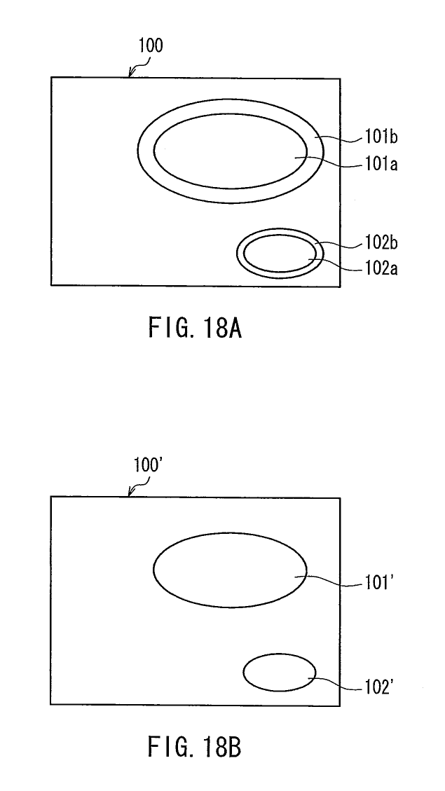

Further, in the liquid crystal display device 1 of the present embodiment, the color reproduction range can be adjusted by the weighting process with the correction coefficients so as to correct the luminance values of the light-emitting diodes 8r, 8g, 8b independently from each other. Thereby, it is possible to display a clear and vivid image while suppressing occurrence of color displacement with respect to the inputted picture signal. Specifically, even when the same picture signals as those shown in FIGS. 18A and 18B are inputted, in the liquid crystal display device 1 of the present embodiment, as shown in FIG. 13, the dark-blue sky 30 can be displayed (reproduced) with the desired dark-blue color. Further, at the respective borders 31b, 32b between the sky 30 and white clouds 31a, 31b, occurrence of color displacement caused by the interference of the B and G color filters is suppressed, and thus displaying of unnatural pictures are avoided to the minimal.

Further, in the liquid crystal display device 1 of the present embodiment, the target color correction computing part (color correction computing part) 20 corrects the R′G′B′ separate signal by using the gradation signal data from the LED image luminance creating part 19, thereby obtaining a R″G″B″ picture luminance signal which is provided by correcting mismatching that occurs due to superposition of the transmission wavelength of the color filter 2d and the emission wavelengths of the light-emitting diode 8r, 8g, 8b. Thereby, in the liquid crystal display device 1 of the present embodiment, the inputted picture signal can be made to a more suitable picture signal, and thus the color reproducibility of the displayed image and the display quality can be improved more surely.

### Embodiment 2

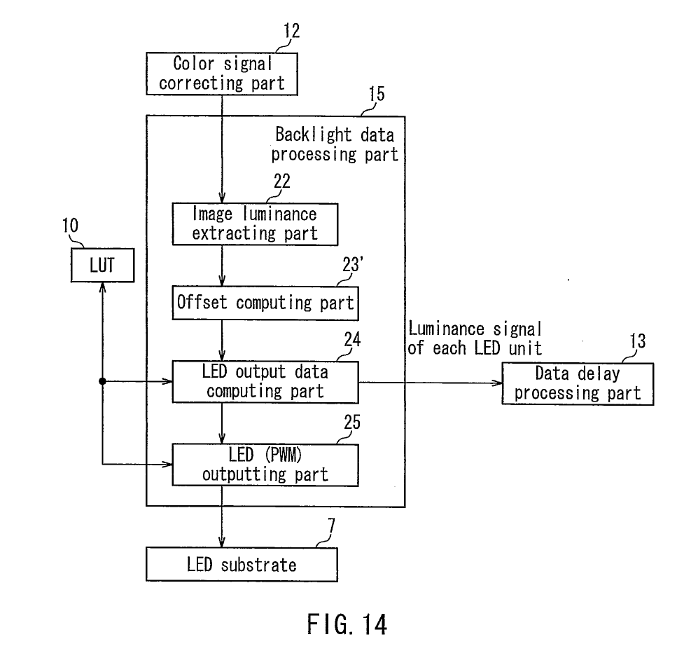

FIG. 14 is a block diagram showing a configuration of a backlight data processing part in a liquid crystal display device according to Embodiment 2 of the present invention. In this drawing, a main difference between the present embodiment and Embodiment 1 is that the offset computing part compares a determined luminance value of green and a determined luminance value of blue by using the inputted picture signal, and determines the larger luminance value as the luminance value of green and also as the luminance value of blue. In the following description of embodiment, the same reference numerals may be assigned to the same components as those of Embodiment 1 in order to avoid the duplication of explanations.

Namely, as shown in FIG. 14, in the liquid crystal display device 1 of the present embodiment, an offset computing part 23′ is provided to the backlight controlling part 15. Similarly to the Embodiment 1, the luminance maximal values for the respective colors of RGB of the displayed image on the respective display areas Pa are to be inputted from the image luminance extracting part 22 to this offset computing part 23′. The offset computing part 23′ compares the luminance maximal value of green and the luminance maximal value of blue, and determines the larger luminance maximal value as the luminance value of green and as the luminance value of blue, and outputs the luminance values to the LED output data computing part 24. In the meantime, the offset computing part 23′ determines, as the luminance value of red, either a luminance maximal value of red at each of the display area Pa inputted from the image luminance extracting part 22 or a value subjected to a predetermined weighting process, and outputs the value to the LED output data computing part 24.

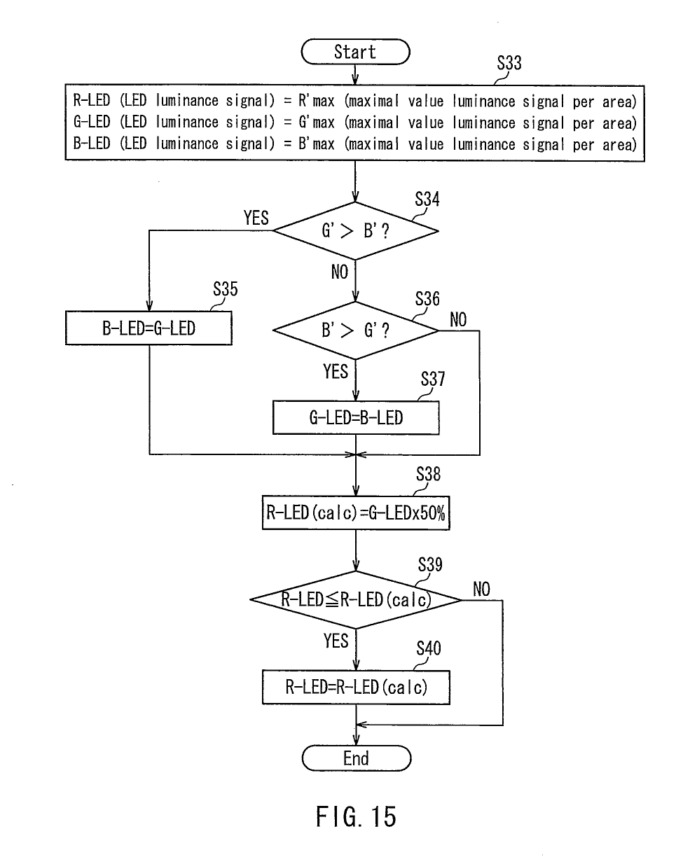

Here, the operation of the liquid crystal display device 1 of the present embodiment will be specified with reference to FIG. 15. The description below refers mainly to the operation of processing in the offset computing part 23′.

FIG. 15 is a flow chart showing operations of an offset computing part as shown in FIG. 14.

As shown in the step S33 in FIG. 15, the offset computing part 23′ sets, in each of the LED units 8 (each illumination area Ha), the respective luminance maximal values of RGB from the image luminance extracting part 22 as the luminance signal values of the corresponding light-emitting diodes 8r, 8g, 8b of the LED unit 8.

Next, the offset computing part 23′ decides whether the luminance signal value of the light-emitting diode 8g (i.e., G′max) is larger or not than the luminance signal value of the light-emitting diode 8b (i.e., B′max) (step S34). And, when it is decided that the luminance signal value of the light-emitting diode 8g is larger, the offset computing part 23′ sets the final luminance signal value of the light-emitting diode 8b as the value equal to the luminance signal value of the light-emitting diode 8g (step S35), and outputs the respective luminance signal values of these light-emitting diodes 8g, 8b to the LED output data computing part 24.

In the step S34, when it is decided that the luminance signal value of the light-emitting diode 8g is not larger than the luminance signal value of the light-emitting diode 8b, the offset computing part 23′ decides whether the luminance signal value of the light-emitting diode 8b is larger or not than the luminance signal value of the light-emitting diode 8g (step S36). When deciding that the luminance signal value of the light-emitting diode 8b is larger, the offset computing part 23′ sets the final luminance signal value of the light-emitting diode 8g as the value equal to the luminance signal value of the light-emitting diode 8b (step S37), and outputs the respective luminance signal values of these light-emitting diodes 8g, 8b to the LED output data computing part 24 during the below-mentioned steps S38-S40.

In the step S36, when it is decided that the luminance signal value of the light-emitting diode 8b is not larger than the luminance signal value of the light-emitting diode 8g, the offset computing part 23′ decides that the luminance signal values of these light-emitting diodes 8g, 8b are the equal values, and outputs the respective luminance signal values of these light-emitting diodes 8g, 8b to the LED output data computing part 24 during the below-mentioned steps S38-S40.

Next, the offset computing part 23′ weights the luminance signal value of the light-emitting diode 8g determined in either the step S33 or S37 by adding up a predetermined correction coefficient (step S38). Namely, a value obtained by multiplying the luminance signal value of the light-emitting diode 8g by 50% is calculated as the weighted luminance signal value (R-LED(calc)) of the light-emitting diode 8r. Here, the light-emitting diode 8g is set as the reference luminance signal for weighting, since its wavelength is the closest to that of the light-emitting diode 8r and influenced considerably by the color displacement.

Subsequently, the offset computing part 23′ compares the value of the LED luminance signal of the light-emitting diode 8r determined in the step S33 (i.e., R′max) and the value of the luminance signal of the light-emitting diode 8r (i.e., R-LED(calc)) that has been weighted in the step S38 (step S39).

And when it is decided that the luminance signal value of the light-emitting diode 8r weighted by the offset computing part 23′ is equal to or larger than the value of R′max, the weighted luminance signal value of the light-emitting diode 8r is used as the final luminance signal value of the light-emitting diode 8r (step S40).

In the above-mentioned step S39, when it is decided that the weighted luminance signal value of the light-emitting diode 8r is smaller than the value of R′max, the offset computing part 23′ uses the value of R′max as the final luminance signal value of the light-emitting diode 8r. When the process of the step S39 or S40 ends, the offset computing part 23′ outputs the respective final luminance signal values of the light-emitting diodes 8r, 8g, 8b to the LED output data computing part 24.

According to the above-mentioned configuration, the liquid crystal display device 1 of the present embodiment can provide the actions and effects as those of Embodiment 1. Further, in the liquid crystal display device 1 of the present embodiment, the offset computing part (luminance determining part) 23′ compares the respective luminance maximal values of green and blue, and determines the larger luminance maximal value as the luminance value of green and as the luminance value of blue, and outputs the values to the LED output data computing part 24. Namely, in the liquid crystal display device 1 of the present embodiment, as shown in FIG. 15, the green and blue colors that interfere most at the color filter 2d are controlled similarly to the monochrome area active drive, while the red color is controlled similarly to the offset luminance drive. Thereby, in the liquid crystal display device 1 of the present embodiment, the offset computing part 23′ can suppress surely color displacement of blue light with respect to the picture signal. Among the colored lights of red, green and blue that are visually recognized by the user through the color filter, the blue light has the highest visibility for the user. Further, in the liquid crystal display device 1 of the present embodiment, occurrence of color displacement can be suppressed more effectively in comparison with an independent type area active drive. And the liquid crystal display device 1 of the present embodiment can display more vividly an image including more area of red color, for example an image of a big red flower, in comparison with a case of the monochrome area active drive, thereby improving the display quality.

The above embodiments are shown merely for an illustrative purpose and are not limiting. The technical range of the present invention is defined by the claims, and all the changes within a range equivalent to the configuration recited in the claims also are included in the technical range of the present invention.

For example, although the above description refers to a case where the present invention is applied to a transmission-type liquid crystal display device, the present invention is not limited to this example but it can be applied also to various non-emission type display devices that display information by using light from a light source. Specifically, the display device of the present embodiment can be used for a semi-transmission type liquid crystal display device or a projection-type display device such as a rear projection type that uses the liquid crystal panel for its light bulb.

Furthermore, although the above description refers to a case where the light source has tricolor light-emitting diodes of RGB at its backlight part, the backlight part of the present invention is not limited particularly as long as the offset luminances are set independently from each other and as long as light sources of at least two colors mixable with white color are used. Specifically for example, for the light sources, a blue light-emitting diode and a light-emitting diode of yellow as a mixed color of red and green both of which are complementary colors of this blue color can be used. Alternatively, a four-color light-emitting diode that includes a tricolor light-emitting diode of RGB and a light-emitting diode of white color can be used. Further, it is possible to use for the light source any other light-emitting components such as an organic electronic luminescence and light-emitting devices such as PDP (Plasma Display Panel).

However, a light source composed of light-emitting diodes is preferred since the color reproducibility and cost performance are superior and a compact light source having high luminance and long life can be configured easily, and thus a small and high-performance display device can be formed easily.

Although the above-description refers to a case where a direct-type backlight device is used for the backlight part, there is no particular limitation for the backlight part as long as a plurality of illumination areas for allowing lights from the light sources to respectively enter with respect to a plurality of display areas established at the display part are provided. Examples of other types of backlight devices include an edge-light type device configured to control the luminance values (light quantity) of a plurality of illumination areas independently from each other, or a tandem type device that is provided with a light-guide for guiding light from a light source for each illumination area. Alternatively, the same liquid crystal panel as the above-described liquid crystal panel is provided between a liquid crystal panel for display and the light sources and an illumination area is set on the liquid crystal panel, and thus the liquid crystal panel can be applied to the backlight part.

### INDUSTRIAL APPLICABILITY

The present invention is effective for a high-performance display device that can improve color reproducibility on a displayed image and that can improve the display quality.

1. A display device comprising:
a backlight part that has light sources; and
a display part that has a plurality of pixels and that is configured to be capable of color display of information by using illumination light from the backlight part,
the display device further comprising:
a plurality of illumination areas that are provided on the backlight part and that allows light from the light sources to enter respectively a plurality of display areas provided on the display part; and
a control part that controls drive of the backlight part and drive of the display part by using an inputted picture signal,
the backlight part is provided with light sources of at least two colors mixable with white light for each of the illumination areas; and
offset luminances of the light sources of at least two colors are set independently from each other.

2. The display device according to claim 1, wherein
the display part is provided with a color filter for each of the pixels,
the control part is provided with a backlight control part that determines for each of the light sources a luminance value of light emitted from each of the plural illumination areas to a corresponding display area by using the inputted picture signal and controls the drive of the backlight part, and
the backlight control part is provided with a luminance determining part that corrects and determines a luminance value determined for each of the light sources by using a correction coefficient preset on the basis of a predetermined CF property of the color filter and a predetermined emission property of the light sources.

3. The display device according to claim 1, wherein
light-emitting components that respectively emit light of red, green and blue are used as the light sources;
the display part is provided with a color filter for each of the pixels;
the control part is provided with a backlight control part that determines for each of the light sources the luminance value of light emitted from each of the illumination areas to a corresponding display area by using an inputted picture signal and controls the drive of the backlight part,
the backlight control part is provided with a luminance determining part that compares the determined luminance value of green and the determined luminance value of blue by using the inputted picture signal, and determines the larger luminance value as the luminance value of green and as the luminance value of blue.

4. The display device according to claim 2, wherein the control part is provided with a display control part that corrects the inputted picture signal by using the luminance value for each of the light sources from the backlight control part, and controls the drive of the display part on the basis of corrected picture signal for each of the pixels, and
the display control part is provided with a color correction computing part that corrects the inputted picture signal by using the CF property.

5. The display device according to claim 4, wherein the display control part corrects the luminance value for each of the light sources from the backlight control part, by using data of a preset PSF (point spread function).

6. The display device according to claim 2, wherein the backlight control part corrects the luminance value of the light source determined at the luminance determining part, by using a preset minimal offset luminance value.

7. The display device according to claim 2, wherein the backlight control part corrects the luminance value for each of the light sources determined at the luminance determining part so that a luminance balance of each illumination area has a value within a predetermined range with respect to an adjacent illumination area.

8. The display device according to claim 2, wherein the backlight control part corrects the luminance value for each of the light sources determined at the luminance determining part so that consistency with a previous display operation at the display part is ensured.

9. The display device according to claim 1, wherein the light sources of at least two colors are light-emitting diodes whose luminescent colors are different from each other.
